(19) United States
(12) Patent Application Publication
(10) Pub. No.: US 2010/0306127 A1
(43) Pub. Date: Dec. 2, 2010

(54) RETIREMENT INCOME SELECTOR SYSTEMS AND METHODS

(76) Inventors: Dan Weinberger, Hillsborough, NJ (US); Alan Assner, Quincy, MA (US); Lisa Kuklinski-Ramirez, New York, NY (US); Joseph Holt McGee, Delray Beach, FL (US)

Correspondence Address: Troutman Sanders LLP, The Chrysler Building, 405 Lexington Avenue, New York, NY, 10174, US

(21) Appl. No.: 12/476,967

(22) Filed: Jun. 2, 2009

(51) Int. Cl. G06Q 40/00

(52) U.S. Cl. 705/36 R

(57) ABSTRACT

The disclosed technology provides systems and methods that provide investors with a product category allocation based on the investor's preferences regarding asset flexibility and guaranteed income. Whereas existing technologies focus on risk and evaluate how an investor's tolerance for risk impacts particular investment choices, the disclosed technology makes no investment choices when it presents a product category allocation to an investor. The product category allocation is presented to the investor on the basis of the investor's preferences regarding asset flexibility and guaranteed income. The product category allocation includes one or more product categories that guarantee income and one or more flexible asset categories. The disclosed technology also provides a computer executing software, where the executed software causes the computer to provide investors with a product category allocation based on the investor's preferences regarding asset flexibility and guaranteed income.

### FIELD OF THE INVENTION

The present invention relates generally to product purchase plans, and more specifically, to systems and methods for providing a product purchase plan based on a person's preferences regarding asset flexibility and guaranteed income.

### BACKGROUND OF THE INVENTION

It is widespread knowledge that saving for retirement as early as possible yields greater accumulation of assets. In addition to the notion of saving early, it is also widespread knowledge that different investment strategies can yield different degrees of asset value changes. One well-known rule of thumb is to allocate a percentage of retirement investments equal to one's age to debt instruments (for example, bonds), and to allocate the remainder to equity (for example, stocks and mutual funds). Based on this strategy, a person thirty years of age would allocate retirement investments by placing 30% in debt instruments and 70% in equity and thereby allowing for a higher degree of asset value changes, and a person sixty years of age would allocate retirement investments by placing 60% in debt instruments and 40% in equity, thereby allowing for a lower degree of asset value changes. Certainly, more sophisticated investment strategies exist. Although there are many different investment strategies, they all have the common characteristic of being directed to asset accumulation. These strategies assume that a person has income (most likely from employment) in excess of expenses and has left over income to set aside for retirement investments. Such asset accumulation strategies, however, fail to address a retiree's situation of having little to no income from employment and of most likely needing to rely on their retirement savings to meet expenses. Accordingly, there is interest in developing strategies that address a retiree's financial situation and in developing technologies that can allow a retiree to benefit from such strategies.

### SUMMARY OF THE INVENTION

The disclosed technology provides systems and methods that provide investors with a product category allocation based on the investor's preferences regarding asset flexibility and guaranteed income. Whereas existing technologies focus on risk and evaluate how an investor's tolerance for risk impacts particular investment choices, the disclosed technology makes no investment choices when it presents a product category allocation to an investor. The product category allocation is presented to the investor on the basis of the investor's preferences regarding asset flexibility and guaranteed income. The product category allocation includes one or more product categories that guarantee income and one or more flexible asset categories. The disclosed technology also provides a computer executing software, where the executed software causes the computer to provide investors with a product category allocation based on the investor's preferences regarding asset flexibility and guaranteed income.

Other features and advantages of the disclosed technology will become more apparent when considered in connection with the accompanying drawings and detailed description.

### BRIEF DESCRIPTION OF THE DRAWINGS

In the drawings:

FIG. 1 is an exemplary form for entering projected retirement financial information;

FIG. 2 is an exemplary form for entering projected expenses during retirement;

FIG. 3 is an exemplary form for determining a person's preferences regarding asset flexibility and guaranteed income;

FIG. 4 is a diagram of various exemplary product category allocations suitable for different preferences regarding asset flexibility and guaranteed income;

FIG. 5 is a diagram of an exemplary product purchase plan in accordance with the disclosed technology;

FIG. 6. is a block diagram of an exemplary network communication system applicable to the disclosed technology; and

FIG. 7 is a block diagram of exemplary components of the retirement income selector computer of FIG. 6.

### DETAILED DESCRIPTION

The disclosed technology provides systems and methods that provide investors with a product purchase plan based on the investor's preferences regarding asset flexibility and guaranteed income. As used herein, the term “asset” refers to anything having monetary value, including, but not limited to, insurance products such as annuities and longevity insurance.

Aspects and embodiments of the disclosed technology will now be described with reference to the drawings. The particular embodiments described herein and in the drawings are exemplary and do not limit the scope of the disclosed technology.

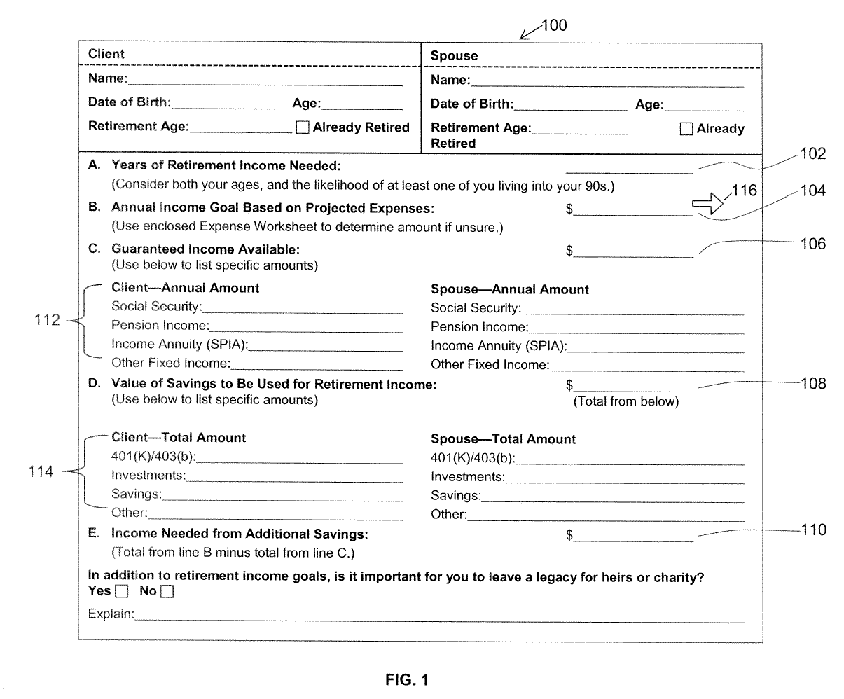

Referring now to FIG. 1, there is shown an exemplary form for entering projected retirement financial information. The form 100 can be a paper form that can be completed using a writing instrument or can be an electronic form running on a computer that can be displayed on a display screen and completed using a keyboard or other suitable input device. The form 100 includes a field 102 for entering an estimate of number of years of retirement income needed, a field 104 for entering a goal for annual income during retirement, a field 106 for entering sources of income that are expected to exist during retirement (such as social security, pension, income annuity), and a field 108 for entering the value of retirement savings that are expected to be available. In the illustrated embodiment, the form 100 includes a field 110 for entering and/or showing a projected income shortfall during retirement. In one embodiment, an investor can manually enter the projected income shortfall into the field 110. In an electronic form embodiment, a computer can compute the projected income shortfall based on the entries in fields 104 and 106 and can display the computed result in field 110. An investor can manually enter expected sources of income into the appropriate fields in portion 112 of the form. In one embodiment, an investor can also enter the sum of the values in fields 112 into the field 106. In an electronic form embodiment, a computer can compute the sum of the values in fields 112 and can display the computed result in the field 106. An investor can enter expected values of retirement savings into the appropriate fields in portion 114 of the form. In one embodiment, an investor can also enter the sum of the values in fields 114 into the field 108. In an electronic form embodiment, a computer can compute the sum of the values in fields 114 and display the computed result in the field 108.

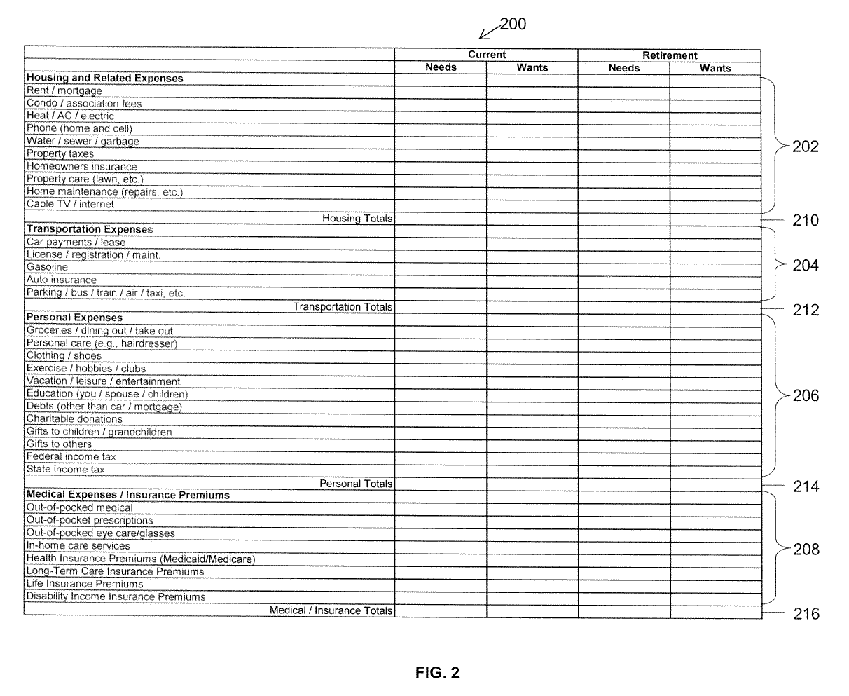

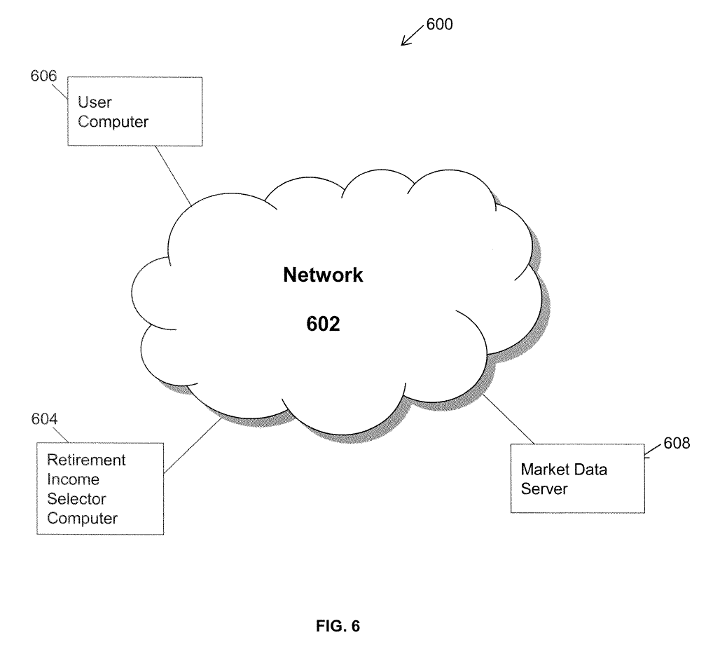

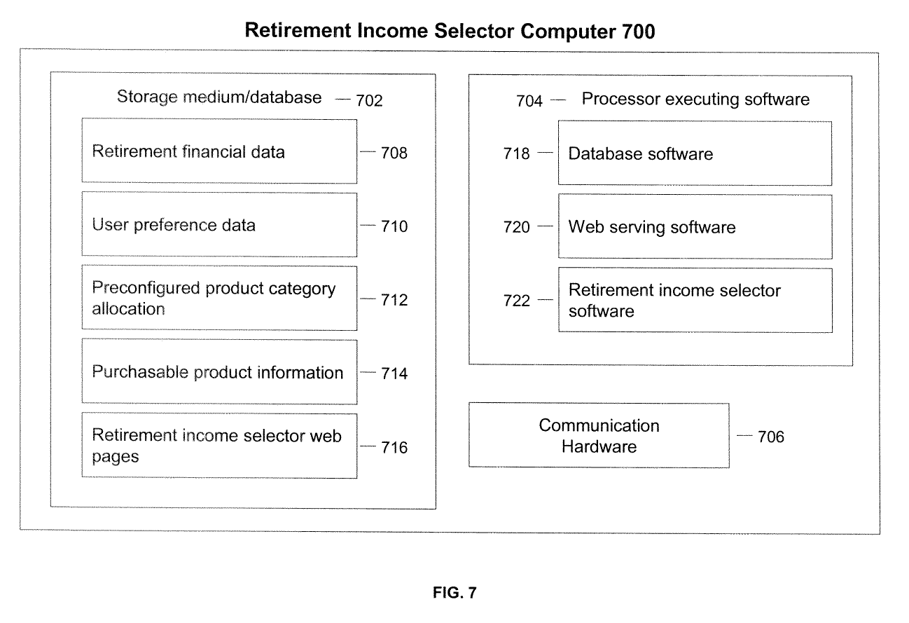

In an electronic form embodiment, the form 100 can include a selectable icon 116 near the field 104 which, when selected, causes an electronic expense worksheet form to be displayed. In a paper form embodiment, the selectable icon 116 can be replaced by an instruction to use an expense worksheet form. One example of an expense worksheet form will be described in connection with FIG. 2. Referring again to FIG. 1, in an electronic form embodiment, the form 100 can include a selectable “save” button (not shown) which, when selected, causes the information in all of the fields 102-114 to be saved into a storage medium/database. A computer and storage medium/database for an electronic form embodiment will be described in detail in connection with FIGS. 6-7.

Referring now to FIG. 2, there is shown an exemplary form for entering projected expenses during retirement. The form 200 can be a paper form that can be completed using a writing instrument or can be an electronic form running on a computer that can be displayed on a display screen and completed using a keyboard or other suitable input device. As mentioned above, in an electronic form embodiment, the form 200 can be displayed when a user selects the icon 116 in the form 100 of FIG. 1. In an electronic embodiment, the form 200 can be displayed in place of the form 100 of FIG. 1. In an electronic embodiment, the form 200 can be displayed concurrently with the form 100 of FIG. 1. For example, the forms 100, 200 can be displayed in non-overlapping portions of a display screen or can be displayed in separate Internet browser “windows” or “tabs” (not shown).

An investor can enter housing expenses into the appropriate fields in portion 202 of the form. In one embodiment, an investor can enter the sum of the values in fields 202 into the row 210. In an electronic embodiment, a computer can compute the sum of the values in fields 202 and display the computed result in the row 210. An investor can enter transportation expenses into the appropriate fields in portion 204 of the form. In one embodiment, an investor can enter the sum of the values in fields 204 into the row 212. In an electronic embodiment, a computer can compute the sum of the values in fields 204 and display the computed result in the row 212. An investor can enter personal expenses into the appropriate fields in portion 206 of the form. In one embodiment, an investor can enter the sum of the values in fields 206 into the row 214. In an electronic embodiment, a computer can compute the sum of the values in fields 206 and display the computed result in the row 214. An investor can enter medical/insurance expenses into the appropriate fields in portion 208 of the form. In one embodiment, an investor can enter the sum of the values in fields 208 into the row 216. In an electronic form embodiment, a computer can compute the sum of the values in fields 208 and display the computed result in the row 216. The list of expenses shown in FIG. 2 is exemplary and does not limit the scope of the disclosed technology. Other expenses are contemplated and can be used in the form 202 for entering projected expenses during retirement.

In an electronic embodiment, the form 200 can include a “save” button (not shown) which, when selected, causes the information in all of the fields 202-216 to be saved into a storage medium/database. In an electronic form embodiment, the form 202 can include a “return” button (not shown) which, when selected, enters the sum of all of the expenses 202-216 into the annual income goal field 104 of FIG. 1. In an electronic form embodiment, selection of the “return” button 220 also causes the form 100 of FIG. 1 to be displayed and/or causes the form 200 of FIG. 2 to be closed. In an electronic form embodiment, selection of the “return” button 220 also causes the information in all of the fields 202-216 to be saved into a storage medium/database.

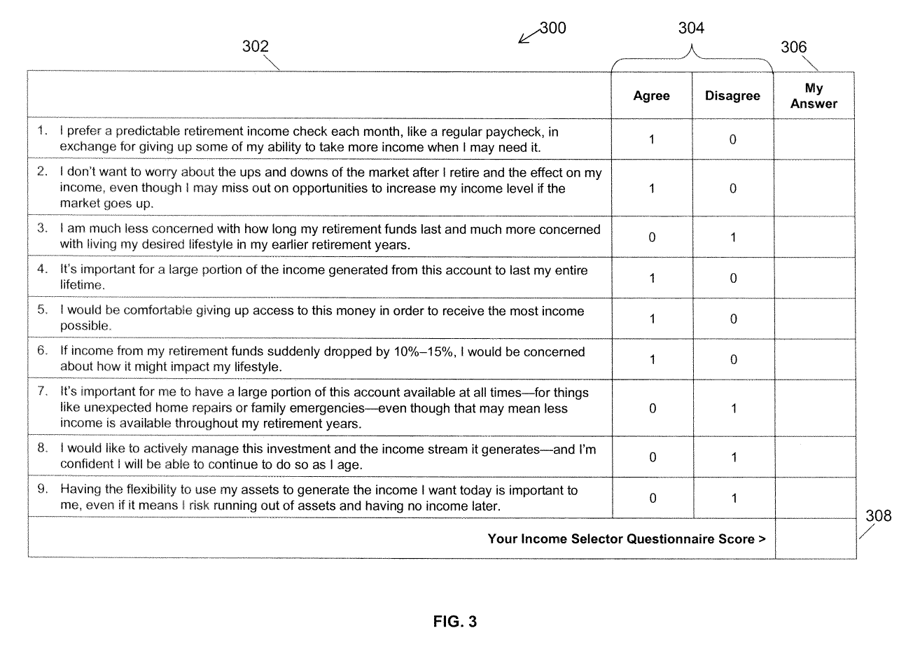

Returning now to FIG. 1, in an electronic form embodiment, the form 100 can include a “next” button (not shown) which, when selected, can cause a computer to determine whether any of the fields 102-110 are blank and awaiting a value. If a value has yet to be entered, a message (not shown) can be displayed to instruct the user to enter any missing values. If there are no missing values, then in one embodiment, selection of such a “next” button can cause all of the information in fields 102-114 to be saved to a storage medium/database, and the disclosed technology can proceed to the form of FIG. 3.

FIG. 3 shows an exemplary form for determining an investor's preferences regarding asset flexibility and guaranteed income. The form 300 can be a paper form that can be completed using a writing instrument or can be an electronic form running on a computer that can be displayed on a display screen and completed using a keyboard or other suitable input device. The illustrated form 300 includes a series of statements and/or questions 302 that are indicative of a user's preference for asset flexible and guaranteed income. As used herein, “asset flexibility” refers to an asset's liquidity, that is, the assets capability of being converted into cash. Examples of flexible assets include stocks, bonds, mutual funds, certificates of deposit, and interest paying savings accounts, among others. The term “guaranteed income” refers to contractual provisions that legally bind a party (such as a company) to an obligation to transfer a stream of cash or some other asset to the beneficiary of the obligation (such as a retiree) for a predetermined period of time or for the duration of the retiree's life. Thus, it will be understood that a product that guarantees income is guaranteed only to the extent that the product's contractual provisions can be legally enforced. Examples of products that guarantee income include annuities and insurance products, such as long term care insurance, longevity insurance, immediate annuities, and variable annuities with a living benefit rider, among others. Generally, flexible assets do not guarantee income, and products that guarantee income cannot easily be liquidated.

With continuing reference to FIG. 3, an investor can agree or disagree with statements/questions 302 in the form 300. In one embodiment, point values are associated with each “agree” response and “disagree” response. In the illustrated embodiment, each point value is either zero or one, but other point values are also contemplated. For example, point values can be greater than one and/or can be negative. In one embodiment, point values for “agree” and “disagree” responses can both be non-zero. In one embodiment, the point values associated with each response may not be displayed to the user. For example, rather than showing the point values as shown in FIG. 3, the columns 304 can simply show “agree” and “disagree.” In one embodiment, an investor can enter “agree” or “disagree” in the response column 306. In an electronic form embodiment, the columns 304 can be selectable, such that when a user selects “agree” or “disagree,” the selection is displayed in the response column 306. In an electronic form embodiment, a computer can compute the sum of point values associated with a user's responses and display the computed result in field 308 as a “score.” In other embodiments, the score may be more complex than a direct sum of point values. In other embodiments, the score can be computed using formulas that take into account the various responses in different ways. In one embodiment, a financial advisor can have a table of point values associated with each response and can apply one or more formulas based on the investor's responses to determine a score.

In one embodiment, the value of the. score indicates the investor's preference regarding asset flexibility and guaranteed income. For example, an investor who prefers asset flexibility may prefer to have liquid assets that can be easily converted into cash to pay for emergency expenses or to invest in various opportunities. Such an investor's responses may result in a low score. On the other end of the spectrum, an investor who prefers guaranteed income so that a known degree of comfort will be secure for the rest of his or her life may prefer to have products that guarantee income. Such an investor's responses may result in a high score. In an electronic embodiment, a computer can compute the score, but the form 300 may not include a field 308 for displaying the score.

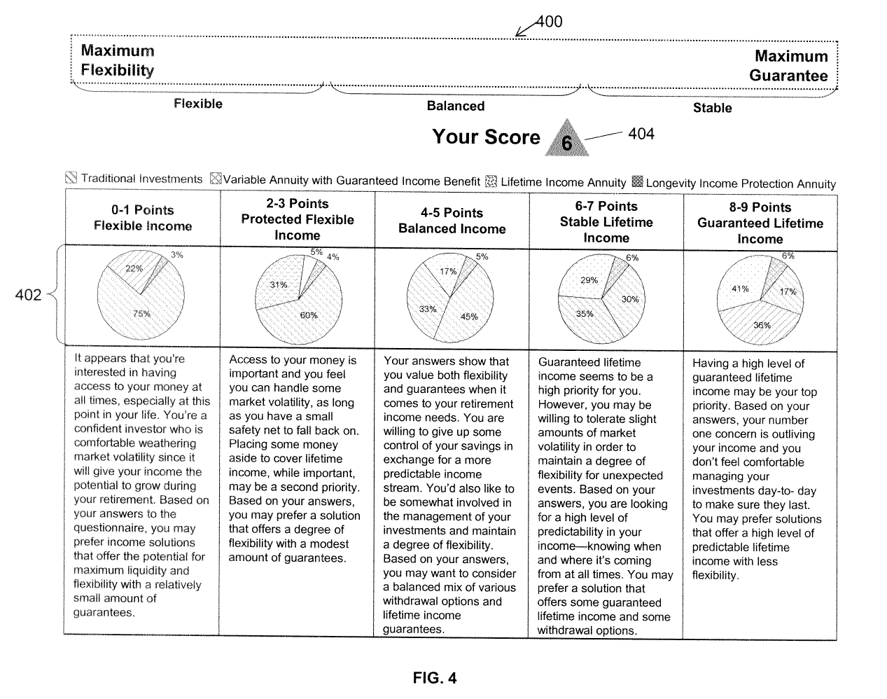

In an electronic form embodiment, the form 300 can include a “save” button (not shown) and a “next” button (not shown). In one embodiment, when the “save” button is selected, the selection causes all of the responses 306 to be stored in a storage medium/database. In one embodiment, when the “next” button is selected, the selection causes a computer to determine whether any of the fields 306 are blank and awaiting a response. If a response has yet to be entered, a message (not shown) can be displayed to instruct the user to enter a response. If there are no missing responses, then in one embodiment, selection of the “next” button causes all of the responses 306 to be saved to a storage medium/database, and the disclosed technology proceeds to the diagram of FIG. 4.

FIG. 4 is a diagram of various exemplary product category allocations suitable for different preferences regarding asset flexibility and guaranteed income. As used herein, the term “product category” refers to different types of products and include, for example, traditional investments/flexible assets (such as stocks, bonds, mutual funds, certificates of deposit, bank accounts), lifetime income annuity, variable annuity with guaranteed income benefit, and longevity income protection annuity, among others. A lifetime income annuity provides an income stream to the annuity purchaser for the life of the purchaser. A longevity income protection annuity is a deferred annuity that provides an income stream to the annuity purchaser for the life of the purchaser that begins after a certain age, such as age eighty-five. A variable annuity with guaranteed income benefit includes two components: traditional investment options that allow potential for growth, as well as insurance features that offer protection against loss. A variable annuity provides the ability to reduce downside risk by offering optional insurance features, often called “living benefit riders,” that can help grow and protect immediate and/or future income. Other types of products can also be considered to fall into different “product categories” and are contemplated to fall within the scope of the disclosed technology.

In the illustrated embodiment of FIG. 4, each of the product category allocations 402 include at least one category of flexible assets and at least one category of products that provide guaranteed income. In one embodiment, each of the product category allocations 402 can be preconfigured to correspond to a particular preference or particular range of preferences regarding asset flexibility and guaranteed income. Those skilled in the art will recognize that there are various techniques and technologies for configuring product category allocations, including mathematical and statistical techniques. Other product category allocations not illustrated are contemplated to be within the scope of the disclosed technology. For example, product category allocations need not include definite percentage splits that sum to 100%, such as, for example, 40% traditional investments, 35% variable annuity with guaranteed income benefit, 15% lifetime income annuity, and 10% longevity income protection annuity. Rather, product category allocations within the scope of the disclosed technology can include percentage ranges for one or more product categories, such as, for example, 35-45% traditional investments, 30-40% variable annuity with guaranteed income benefit, 10-20% lifetime income annuity, and 5-15% longevity income protection annuity.

In the illustrated embodiment, the left-most product category allocation corresponds to greater asset flexibility and includes a higher percentage of flexible asset categories and a lower percentage of product categories that guarantee income. The right-most product category allocation corresponds to greater guaranteed income and includes a lower percentage of flexible asset categories and a higher percentage of product categories that guarantee income. The product category allocations in between correspond to a more balanced combination of flexible asset categories and product categories that guarantee income. In one embodiment, as shown in FIG. 4, each product category allocation 402 can be associated with one or more scores in the range of potential scores computed based on the form 300 of FIG. 3. In the illustrated embodiment, lower scores indicate preference for asset flexibility and higher scores indicate preference for guaranteed income, and scores in between indicate preference for a more balanced combination of asset flexibility and guaranteed income. The illustrated association between score values and product category allocations is exemplary and do not limit the score of the disclosed technology. Other associations are contemplated.

In one embodiment, the product category allocations 402 can also be associated with a particular age or a target age group. For example, the illustrated product category allocations 402 may be applicable to an investor of age sixty-five but not applicable to an investor of age eighty-five. For an investor of age eighty-five, a different group of product category allocations (not shown) can be used. In one embodiment, an advisor can determine one or more suitable groups of product category allocations to present to an investor. In an electronic embodiment, a computer and/or an advisor can determine one or more suitable groups of product category allocations to present to an investor.

In an electronic display embodiment, the diagram 400 can display the investor's score 404. In one embodiment, the investor's score 404 can be displayed near the product category allocation associated with that score. In an electronic display embodiment, the diagram 400 can display only the product category allocation associated with the investor's score 404. As mentioned above herein, the disclosed technology for evaluating an investor's preference regarding asset flexibility and guaranteed income and for using that evaluation to present a product category allocation to the investor is different from existing technologies. Whereas existing technologies focus on risk and evaluate how an investor's tolerance for risk impacts particular investment choices, the disclosed technology makes no investment choices when it presents a product category allocation to an investor. The product category allocation is presented to the investor on the basis of an investor's preferences regarding asset flexibility and guaranteed income.

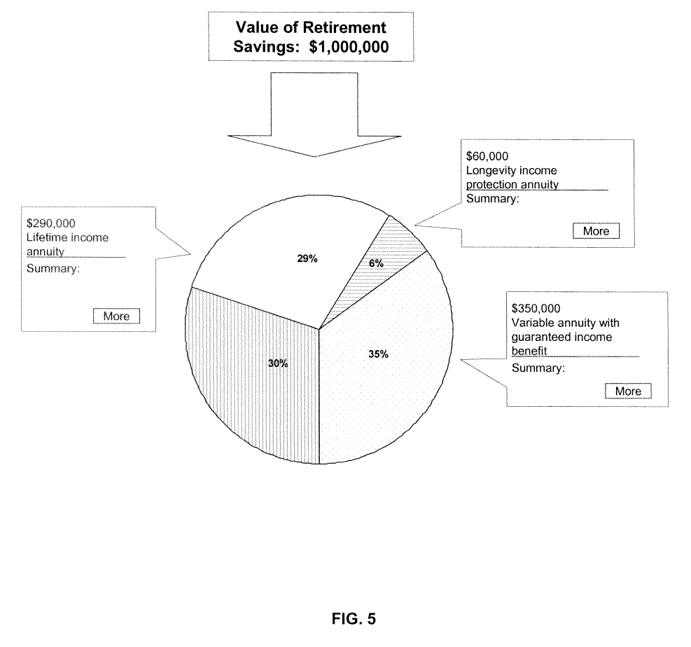

In an electronic display embodiment, the diagram 400 can include a “next” button (not shown) which, when selected, causes the disclosed technology to compute and display a product purchase plan as shown in FIG. 5.

FIG. 5 shows a diagram of an exemplary product purchase plan in accordance with one aspect of the disclosed technology. In one aspect of the disclosed technology, the retirement financial information entered in the form 100 of FIG. 1 and the product category allocation associated with the investor's score (FIG. 4) are combined to compute a product purchase plan. In the illustrated example, the investor's score corresponds to a product category allocation that is comprised of 35% variable annuity with guaranteed income benefit, 30% traditional investments, 29% lifetime income annuity, and 6% longevity income protection annuity. Suppose the value of available retirement savings is $1,000,000. Distributing this amount under the product category allocation, $350,000 would be available for a variable annuity with guaranteed income benefit, $300,000 would be available for traditional investments, $290,000 would be available for a lifetime income annuity, and $60,000 would be available for a longevity income protection annuity. In one embodiment, an advisor an present this product purchase plan to an investor. In an electronic embodiment, a computer can compute the product purchase plan and display it on an electronic display.

In one aspect of the disclosed technology, in an electronic display embodiment, a computer can maintain and/or access a list of purchasable products in each product category. The computer can display a summary of the product category. In one embodiment, a “more” button can be located under the summary. In one embodiment, when the “more” button is selected, a screen display of product choices in the product category can be displayed.

Using the product purchase plan, an investor can discuss the product choices with an advisor to address the investor's retirement financial situation. For example, an advisor can consider the investor's retirement income shortfall shown in the form 100 of FIG. 1 and advise the investor regarding which product choices can best reduce the investor's retirement income shortfall. Products that guarantee income can directly reduce the retirement income shortfall. Flexible assets can be sold in a planned manner to reduce the retirement income shortfall. An investor's product category allocation and product purchase plan serve as starting points for this retirement financial planning between an investor and an advisor.

What have been described thus far are exemplary forms for allowing an investor to enter projected retirement financial information and preferences regarding asset flexibility and guaranteed income, and exemplary diagrams for presenting an investor's recommended product category allocation and product purchase plan. Computer systems for implementing these aspects and embodiments will now be described in connection with FIGS. 6-7.

FIG. 6 is a block diagram of an exemplary network communication system applicable to the electronic form and electronic display embodiments of the disclosed technology. The network communication system 600 includes a network 602, a retirement income selector computer 604, and one or more user computers 606. The network communication system 600 can also include one or more market data servers 608. It will be understood that the user computers 606 can include computers used by financial advisors, sales professionals, and/or sales representatives. As used herein, the term “computer” includes any system or device that can execute machine instructions, including, for example, desktops, laptops, servers; handheld devices, television set top boxes, and/or networked computing systems, or multiples or combinations thereof. The user computer 606 can include hardware such as network communication devices, storage medium/devices, processors, memory, computer boards, optical or magnetic drives, human interface devices, and/or other types of hardware, and software such as operating system software, Web browsing software, database management software, software supporting various communication protocols, software supporting various programming languages, and/or other types of software.

In one aspect of the disclosed technology, the user computer 606 can communicate with the retirement income selector computer 604 through the network 602. The network 602 may include one or more telecommunication devices such as routers, hubs, gateways, and the like, as well as one or more connections such as wired connections or wireless connections. In different embodiments, the network 602 can include different numbers of telecommunication devices and connections and can span a range of different geographies. In different embodiments, the network 602 can include all or portions of a wired telephone infrastructure, a cellular telephone infrastructure, a cable television infrastructure, a fiber optic infrastructure, and/or a satellite television infrastructure.

In one aspect of the disclosed technology, the retirement income selector computer 604 can include Web server software and the user computer 606 can include Web browsing software. The retirement income selector computer 604 can present the forms in FIGS. 1-3 and display the diagrams in FIGS. 4-5 as Web pages, which the user computer 606 can access using a Web browser. In one aspect of the disclosed technology, the retirement income selector computer 604 can communicate with a market data server 608 to obtain market data that the retirement income selector computer 604 can use, such as a listing of purchasable products in each product category.

FIG. 7 is a block diagram of exemplary components of the retirement income selector computer of FIG. 6. The retirement income selector computer 700 includes a storage medium/database 702, a processor executing software 704, and communication hardware 706, among other computer-related components (not shown). The storage medium/database 702 can store retirement financial data 708 entered in the forms of FIGS. 1-2, user preference data 710 entered in the form of FIG. 3, preconfigured product category allocations 712 such as the exemplary product category allocations shown in FIG. 4, product information 714 for use in the listing products for each product category in the product purchase plan, and retirement income selector Web pages 716 that display the forms and diagrams of FIGS. 1-5. The processor executing software 704 can execute database software 704 for managing the data in the storage medium/database 702, Web serving software 720 for managing access to and interactions with the retirement income selector Web pages 716, and retirement income selector software 722 that computes the financial values in FIGS. 1-2, the score in FIGS. 3-4, and/or the product purchase plan shown in FIG. 5. The retirement income selector software 722 can compute the product purchase plan based on the preconfigured product category allocation information 712 stored in the storage medium/database 702. The retirement income selector software 722 can also use the communication hardware 706 to access information from a market data server (608, FIG. 6) to access available products for each product category in the product purchase plan.

What have been described are systems and methods that provide investors with a product purchase plan based on an investor's preferences regarding asset flexibility and guaranteed income. Various embodiments of the disclosed technology have been described herein, and various embodiments are described below. The embodiments should not be considered to be mutually exclusive. It is contemplated that various embodiments can be combined.

In one aspect of the disclosed technology, the disclosed technology provides a computer implemented method of determining a product purchase plan that includes one or more products that guarantee income. The computer implemented method accesses, by a computer, information indicating preferences regarding asset flexibility and guaranteed income, and determines, by the computer, a product category allocation based on the information, wherein the product category allocation includes one or more product categories that guarantee income and one or more flexible asset categories. In one embodiment, product categories that guarantee income include annuities and insurance products, and flexible asset categories include stocks, bonds, mutual funds, certificates of deposit, and interest paying savings accounts. In one embodiment, the computer implemented method accesses a total value available for purchasing products, computes values available for purchasing products for each product category in the product category allocation by applying the product category allocation to the total value, and displays the values as a product purchase plan.

In one embodiment, determining the product category allocation based on the information includes selecting one of a plurality of preconfigured product category allocations based on the information. In one embodiment, a preconfigured product category allocation is selected based on a score, wherein lower scores indicate preference for asset flexibility, higher scores indicate preference for guaranteed income, and scores in between indicate preference for a more balanced combination of asset flexibility and guaranteed income. In one embodiment, the plurality of preconfigured product category allocations include product category allocations for a target age group, wherein determining the product category allocation considers an age of said user. In one embodiment, the plurality of preconfigured product category allocations includes product category allocations comprised of lower percentages of product categories that guarantee income and higher percentages of flexible asset categories, and include product category allocations comprised of higher percentages of product categories that guarantee income and lower percentages of flexible asset categories.

In one aspect of the disclosed technology, the computer implemented method displays a series of questions to a user, wherein each question is predictive of either a preference for asset flexibility or a preference for guaranteed income, receives responses to the series of questions from the user, computes a score based on the responses, wherein the score indicates preferences regarding asset flexibility and guaranteed income, and stores the responses and the score as information indicating preferences regarding asset flexibility and guaranteed income.

In one aspect of the disclosed technology, the computer implemented method displays a series of questions to a user regarding projected future income and expenses, receives responses to the series of questions from the user, determines based on the responses that projected future income fails to meet a projected future income goal so that a projected income shortfall exists, and stores the projected income shortfall.

One aspect of the disclosed technology provides a computer executing software, wherein the executed software causes the computer to perform steps in accordance with one or more of the aspects and embodiments described above in connection with the disclosed computer implemented method.

Embodiments of the present invention comprise software and computer components and software and computer-implemented steps that will be apparent to those skilled in the art. For ease of exposition, not every step or element of the present invention is described herein as part of software or computer system, but those skilled in the art will recognize that each step or element may have a corresponding computer system or software component. Such computer system and/or software components are therefore enabled by describing their corresponding steps or elements (that is, their functionality), and are within the scope of the present invention.

It will be appreciated that the present invention has been described by way of example, and that the invention is not to be limited by the specific embodiments described herein. Improvements and/or modifications may be made to the invention without departing from the scope or spirit thereof.

What is claimed is:

1. A computer implemented method of determining a product purchase plan that includes at least one product that guarantees income, the method comprising:
accessing, by a computer, information indicating preferences regarding asset flexibility and guaranteed income; and
determining, by said computer, a product category allocation based on said information, wherein said product category allocation comprises at least one product category that guarantees income and at least one flexible asset category.

2. A computer implemented method as in claim 1, further comprising:
displaying a series of questions to a user, wherein each question is predictive of one of: a preference for asset flexibility and a preference for guaranteed income;
receiving responses to said series of questions from said user;
computing a score based on said responses, wherein said score indicates preferences regarding asset flexibility and guaranteed income; and
storing said responses and said score as information indicating preferences regarding asset flexibility and guaranteed income.

3. A computer implemented method as in claim 2, wherein determining said product category allocation based on said information comprises selecting one of a plurality of preconfigured product category allocations based on said score, wherein lower scores indicate preference for asset flexibility, higher scores indicate preference for guaranteed income, and scores in between indicate preference for a more balanced combination of asset flexibility and guaranteed income.

4. A computer implemented method as in claim 1, wherein determining said product category allocation based on said information comprises selecting one of a plurality of preconfigured product category allocations based on said information.

5. A computer implemented method as in claim 4, wherein said plurality of preconfigured product category allocations include product category allocations for a target age group, and wherein determining said product category allocation considers an age of said user.

6. A computer implemented method as in claim 4, wherein said plurality of preconfigured product category allocations include product category allocations comprised of lower percentages of product categories that guarantee income and higher percentages of flexible asset categories, and include product category allocations comprised of higher percentages of product categories that guarantee income and lower percentages of flexible asset categories.

7. A computer implemented method as in claim 1, wherein product categories that guarantee income include at least one of: annuities and insurance products, and wherein flexible asset categories include at least one of: stocks, bonds, mutual funds, certificates of deposit, and interest paying savings accounts.

8. A computer implemented method as in claim 1, further comprising:
displaying a series of questions to a user regarding projected future income and expenses;
receiving responses to said series of questions from said user;
determining based on said responses that projected future income fails to meet a projected future income goal so that a projected income shortfall exists; and
storing said projected income shortfall.

9. A computer implemented method as in claim 1, further comprising:
accessing a total value available for purchasing products;
computing values available for purchasing products for each product category in said product category allocation by applying said product category allocation to said total value; and
displaying said values as a product purchase plan.

10. A computer executing software for determining a product purchase plan that includes at least one product that guarantees income, wherein the executed software causes the computer to perform steps comprising:
accessing, by a computer, information indicating preferences regarding asset flexibility and guaranteed income; and
determining, by said computer, a product category allocation based on said information, wherein said product category allocation comprises at least one product category that guarantees income and at least one flexible asset category.

11. A computer executing software as in claim 10, wherein the executed software causes the computer to perform further steps comprising:
displaying a series of questions to a user, wherein each question is predictive of one of: a preference for asset flexibility and a preference for guaranteed income;
receiving responses to said series of questions from said user;
computing a score based on said responses, wherein said score indicates preferences regarding asset flexibility and guaranteed income; and
storing said responses and said score as information indicating preferences regarding asset flexibility and guaranteed income.

12. A computer executing software as in claim 11, wherein determining said product category allocation based on said information comprises selecting one of a plurality of preconfigured product category allocations based on said score, wherein lower scores indicate preference for asset flexibility, higher scores indicate preference for guaranteed income, and scores in between indicate preference for a more balanced combination of asset flexibility and guaranteed income.

13. A computer executing software as in claim 10, wherein determining said product category allocation based on said information comprises selecting one of a plurality of preconfigured product category allocations based on said information.

14. A computer executing software as in claim 13, wherein said plurality of preconfigured product category allocations include product category allocations for a target age group, and wherein determining said product category allocation considers an age of said user.

15. A computer executing software as in claim 13, wherein said plurality of preconfigured product category allocations include product category allocations comprised of lower percentages of product categories that guarantee income and higher percentages of flexible asset categories, and include product category allocations comprised of higher percentages of product categories that guarantee income and lower percentages of flexible asset categories.

16. A computer executing software as in claim 10, wherein product categories that guarantee income include at least one of: annuities and insurance products, and wherein flexible asset categories include at least one of: stocks, bonds, mutual funds, certificates of deposit, and interest paying savings accounts.

17. A computer executing software as in claim 10, wherein the executed software causes the computer to perform further steps comprising:
displaying a series of questions to a user regarding projected future income and expenses;
receiving responses to said series of questions from said user;
determining based on said responses that projected future income fails to meet a projected future income goal so that a projected income shortfall exists; and
storing said projected income shortfall.

18. A computer executing software as in claim 10, wherein the executed software causes the computer to perform further steps comprising:
accessing a total value available for purchasing products;
computing values available for purchasing products for each product category in said product category allocation by applying said product category allocation to said total value; and
displaying said values as a product purchase plan.
